(19) United States
(12) Patent Application Publication
(10) Pub. No.: US 2013/0311595 A1
(43) Pub. Date: Nov. 21, 2013

(54) REAL-TIME CONTEXTUAL OVERLAYS FOR LIVE STREAMS

(71) Applicants: Bianca Milatinovici, Zurich (CH); Christian Ingemar Falk, Zurich (CH); Silviu Bota, Horgen (CH)

(72) Inventors: Bianca Milatinovici, Zurich (CH); Christian Ingemar Falk, Zurich (CH); Silviu Bota, Horgen (CH)

(73) Assignee: GOOGLE INC., Mountain View, CA (US)

(21) Appl. No.: 13/476,990

(22) Filed: May 21, 2012

(51) Int. Cl. G06F 15/167

(52) U.S. Cl. 709/214

(57) ABSTRACT

A system and method for contextualizing and live-updating overlay data for live media streams is disclosed herein. Overlays can be generated in real-time and in response to live events. The overlays can be transmitted to a recipient of a live media stream independently of the live media stream. Overlay data can thus be modified and added to overlays in near-real-time as events occur during a live broadcast without having to modify the live media stream. The overlays can also be contextualized to provide relevant information and context for the live media stream recipient. Such context can include providing a history of the broadcast, and other pertinent information such as incorporating location-based information, demographic information, and other information associated with potential viewers.

### TECHNICAL FIELD

This disclosure relates generally to real time contextual overlays for live streams, and specifically to adding, attaching and transmitting data for overlays in near-real-time as events occur during a live broadcast.

### BACKGROUND

Live streaming current events over the Internet increases demand for a reliable streaming infrastructure. Live streaming feeds are commonly used for major political speeches and events, sporting events, and other cultural happenings. Generally, overlay distribution systems on live video streams are delivered using the same channel as the live video stream (e.g., a same channel).

Inserting, retrieving, and presenting textual and contextual overlays on streamed digital video during live broadcasts has traditionally been done by modifying the video stream itself. When the overlays are a part of the video stream, updates to the overlays require updating the entire video stream, increasing latency as well as bandwidth and processing costs.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

Systems and methods disclosed herein relate to providing real-time updates to overlays and transmitting overlays separately from the media stream. Disclosed herein is a system including a capture component that receives overlay data and replicates the overlay data to memory caches. Also included is a contextualization component that analyzes the overlay data and contextualizes the overlay data in response to analyzing the overlay data. Also included is an overlay component that transmits the contextualized overlay data with the live media stream, where the contextualized overlay data is transmitted in a separate channel from the live media stream.

Also disclosed herein a method including receiving overlay data and replicating the overlay data to a memory cache. The method includes analyzing the overlay data and contextualizing the overlay data in response to analyzing the overlay data and transmitting the contextualized overlay data with the live media stream in separate channels. The method further includes translating the overlay data into a selected language in response to receiving a request for translation to the selected language and updating the contextualized overlay data with live updates as the live updates to the overlay data are received.

Further disclosed herein is a system that includes a streaming component that downloads a media stream and a polling component that polls a cache for an overlay associated with the media stream and downloads the overlay separately from the media stream in response to detecting an overlay. Included also is a display component that synchronizes the overlay with the media stream and displays the media stream with the overlay and also displays a timeline mark in a media stream.

Also disclosed herein is a method that includes downloading a media stream, polling a cache for an overlay associated with the media stream and downloading the overlay separately from the media stream in response to detecting a contextualized overlay. The method also includes synchronizing the overlay with the media stream and displaying the overlay and the media stream together, where displaying the overlay includes displaying a timeline mark in a media timeline, the timeline mark indicating a presence and time of the overlay.

The following description and the annexed drawings set forth in detail certain illustrative aspects of this disclosure. These aspects are indicative, however, of but a few of the various ways in which the principles of this disclosure may be employed. This disclosure is intended to include all such aspects and their equivalents. Other advantages and distinctive features of this disclosure will become apparent from the following detailed description of this disclosure when considered in conjunction with the drawings.

### BRIEF DESCRIPTION OF THE DRAWINGS

FIG. 1 is a block diagram illustrating an example, non-limiting embodiment of system for providing an overlay stream in accordance with various aspects and implementations described herein.

FIG. 2 is a block diagram illustrating an example, non-limiting embodiment of system for receiving, processing, and transmitting overlay data in accordance with various aspects and implementations described herein.

FIG. 3 is a block diagram illustrating an example, non-limiting embodiment of a system that can store live streaming media for video-on-demand playback in accordance with various aspects and implementations described herein.

FIG. 4 is a block diagram illustrating an example, non-limiting embodiment of a system that contextualizes overlays in accordance with various aspects and implementations described herein.

FIG. 5 is a block diagram illustrating an example, non-limiting embodiment of a system that can receive and display contextualized overlays in accordance with various aspects and implementations described herein.

FIG. 6 is a block diagram illustrating an example, non-limiting embodiment of a system that can display timeline marks in accordance with various aspects and implementations described herein.

FIG. 7 illustrates a flow diagram of an example, non-limiting embodiment for contextualizing overlay data in accordance with various aspects and implementations described herein.

FIG. 8 illustrates a flow diagram of an example, non-limiting embodiment for receiving and synchronizing overlay data in accordance with various aspects and implementations described herein.

FIG. 9 is a block diagram illustrating an example computing device that is arranged in accordance with various aspects and implementations described herein.

FIG. 10 is a block diagram illustrating an example networking environment in accordance with various aspects and implementations of this disclosure.

### DETAILED DESCRIPTION

### Overview

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure may be practiced without these specific details, or with other methods, components, materials, etc. In other instances, well-known structures and devices are shown in block diagram form to facilitate describing one or more aspects.

It is to be appreciated that in accordance with one or more implementations described in this disclosure, users can opt-out of providing personal information, demographic information, location information, proprietary information, sensitive information, or the like in connection with data gathering aspects. Moreover, one or more implementations described herein can provide for anonymizing collected, received, or transmitted data.

As used herein, a live video stream includes video data, generated and distributed in real time to multiple recipients. An overlay can refer to any visual element visible on a video that was originally not a part of the live video stream. Overlays can comprise text, and/or geometric shapes and may be applied to the video either during or before it is displayed on a user's device. Overlays can be generated in real-time and in response to live events. A live overlay stream is a stream of overlays, created and distributed in real time to multiple overlay recipients. An overlay distribution system is a system for delivering overlays to multiple, possibly geographically distributed overlay recipients.

Overlays data can be modified and added to overlays and transmitted in near-real-time as events occur during a live broadcast. Textual data can be typed in by an operator observing the event and the data can be written to a data store and replicated quickly to multiple data caches for distribution to client players. The overlays can be analyzed and contextualized based on the analysis. Such contextualization can add information that would be useful to viewers of the media stream as well as provide context for the media broadcast. Such context can include providing a history of the broadcast, and other pertinent information such as incorporating location-based information, demographic information, and other information associated with potential viewers.

A client viewer can poll the data store at regular intervals, via the caches to request any overlays created since the last poll. Any such overlays are transmitted by a separate band or channel than the video stream, and resynchronized by the client viewer. They are then displayed either on the video itself or as marks on the video timeline, with the text displayed when the viewer hovers over the mark on the timeline. In situations where the video can be repositioned to a time earlier than the present (digital video recording enabled live streams), the timeline marks can act as reference points for significant events, allowing a user joining a live stream late to quickly catch up with the significant events so far, and then return to viewing the live stream.

The system and methods disclosed herein also include localizing the text into the viewer's language using a low latency translation service. Such translations are low latency as only the overlay data needs to be processed as the overlay data is separate from the media stream. The overlays can also be updated as events unfold, such as betting odds on the outcome of the match, as the match is progressing. The overlays can also be retained, in synchronization with the media stream, when the live stream is captured for later playback as video-on-demand.

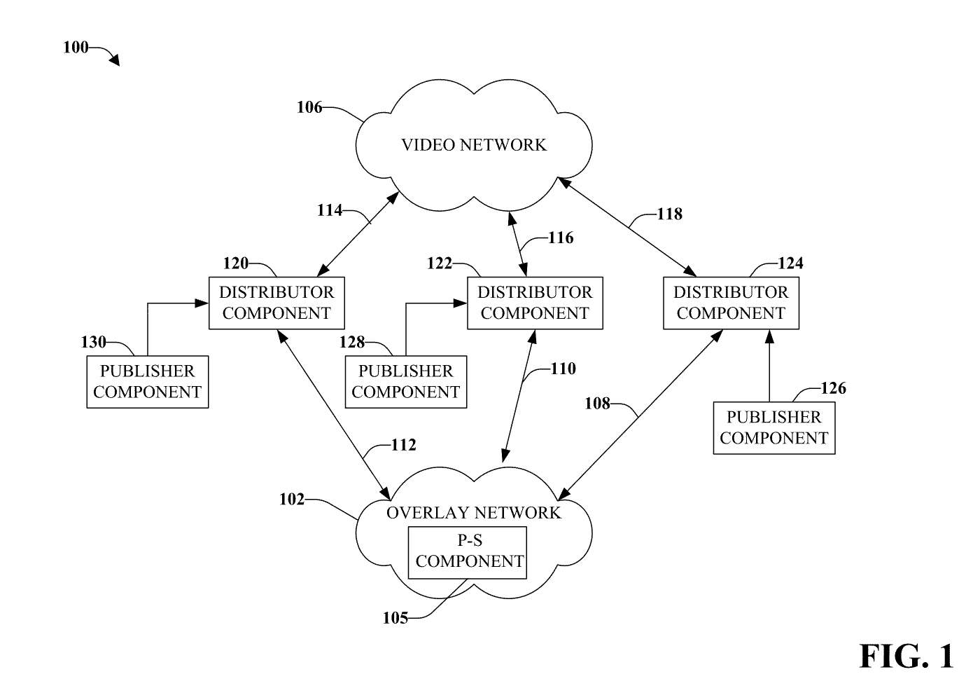

Referring initially to FIG. 1, illustrated is a system 100 that operates as an overlay distribution system that distributes overlay streams having overlay messages to various clients. The system 100 comprises an overlay network 102 that is communicatively connected to a plurality of overlay distribution components 120, 122, and 124, which are also communicatively connected to a video network 106 that distributes live events in a video stream channel.

The overlay network 102 includes a publisher subscriber system component 105 that communicatively couples the plurality of overlay distribution components 120, 122, and 124 with one another for distribution of one or more overlay streams in overlay channels 108, 110 and/or 112. Overlay distribution components 120, 122, and 124 include overlay publisher components 126, 128, and 130 that generate an overlay stream having overlay messages that correspond to events of video streams in real time, which are distributed from channels 114, 116, and 118 from the video network 106, which are separate and different distribution channels from the overlay stream channel. Although channels 114, 116, and 118 are shown in connection to the plurality of overlay distribution components, the example illustrated is not limited to only the video channels 114, 116, and 118. For example, the video network 106 can also distribute video streams to the overlay network 102 and the overlay publishing components 126, 128, and 130.

The system 100 operates as a distribution network that distributes overlay streams having data images, overlay messages, and/or video data to overlay events occurring in a separate video stream distributed in a separate channel for user viewing. For example, a live video stream of a swim competition can be distributed across the video network, which can include a broadcasting network, or some other distribution network that distributes the video streams live or in real time of the swim competition. Concurrent to the live video stream feed of the swim competition, an overlay or separate image data is distributed corresponding to the live streaming events of the swim competition. For example, a gun-shot starting the race could be streamed in a video channel, while at the same time words or text such as “START” could flash on the bottom of a presentation screen for user viewing.

In other examples, various annotations can be part of the overlay stream and the overlay messages therein. For example, small symbols can be displayed on top of a seekbar or control feature bar controllable by the user in design and position. The small symbols can be visible from everywhere in the live distributed video, signaling major events in the stream (e.g., goal, win, score, foul, crash, etc.) depending upon the events. On roll over the bar can show a tooltip (with a video screen shot of that specific time) with more details. Each annotation has a Cue Range associated to it. Aside from this, a marker annotation will also have a seekbar ball marker associated to it, which will be automatically added to the seekbar. The annotation text can also be sent forward the seekbar to be displayed accordingly. In another embodiment, each play by play (timeline) annotation can be supplied to the video data through the overlay and time line data.

The overlay publishing components 126, 128 and 130 publish in real time overlay streams that can be different from one another depending upon a demographic, a geographical location, region or the like. For example, the overlay publisher component 130 can publish in real time an overlay corresponding to events distributed in real time. The overlay publisher component 130 thus submits publishing request to an associated distributor, such as the overlay distribution component 120. In response to the published overlay messages received by the overlay publisher component 130, the overlay distribution component 120 can automatically forward these overlay components to subscriber units (not shown) and/or to the publisher subscriber system component.

In one example embodiment, the overlay channels used to communicate the overlay streams can be separate channels from the video stream channels for viewing the events live. For example, the overlay streams can be unicasted and communicated separately from the at least one overlay distribution component to one or more of the plurality of overlay distribution components 120, 122 and 124. In one embodiment, the publisher subscriber system component 105 receives a request from one or more of the overlay distribution components 120, 122 and 124. The publisher subscriber system component 105 could further distribute overlay streams published to other overlay distribution components that do not have local access (e.g., via a local cache or local store) to a particular overlay stream from a local or associated overlay publisher component. For example, the publisher subscriber system component 105 can distribute published overlay streams from overlay publisher components to overlay distribution components having not stored the published overlay streams requested by other non-local clients, or to overlay distribution components that are at least partially not communicatively connected to a portion of the overlay publisher components publishing the published overlay streams in order to provide requested access to a client viewing the events in the video stream live.

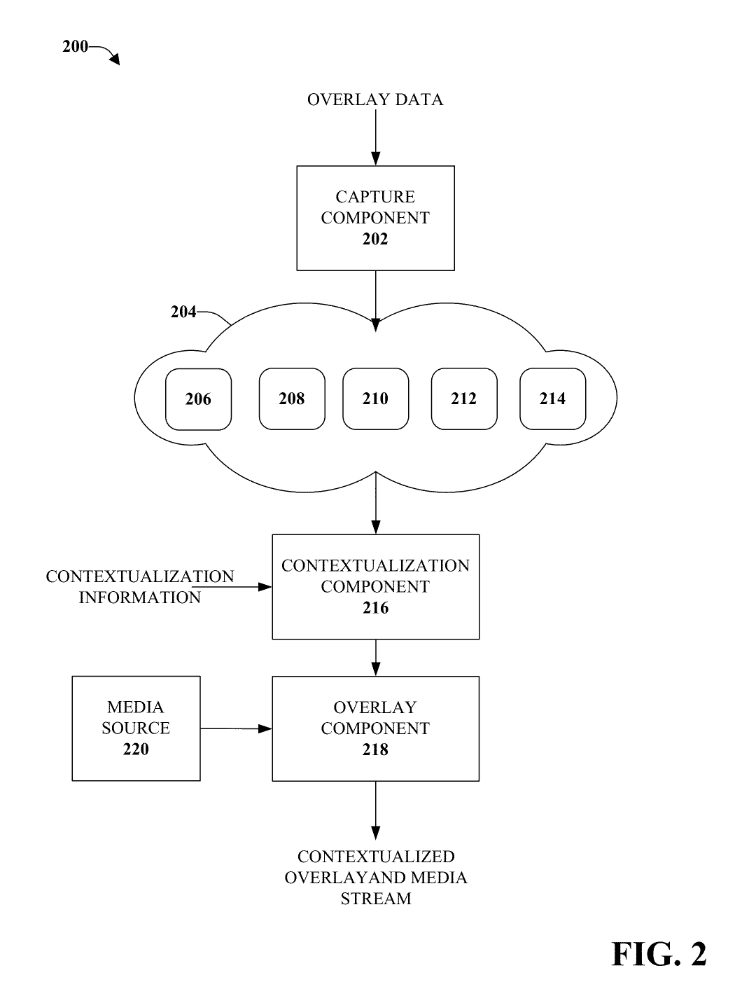

Turning now to FIG. 2, a system for receiving, processing, and transmitting overlay data in accordance with various aspects and implementations disclosed herein. Provided in system 200 is a capture component 202 that receives overlay data and replicates the overlay data to memory caches 206, 208, 210, 212, and 214 in a distribution network 204. Contextualization component 216 analyzes the overlay data and contextualizes the overlay data in response to analyzing the overlay data. Provided also is an overlay component 218 that receives a live media stream from media source 220, and transmits the contextualized overlay data with the live media stream in separate channels.

In an embodiment of the present disclosure, capture component 202 can receive the overlay data from an overlay data operator that enters the overlay data based on a live broadcast. The overlay data can provide context and additional information related to the events occurring on the live broadcast. The overlay data entered by the operator can also inform viewers of the live broadcast about upcoming and past events. The overlay data entered can be text-based and/or picture-based. The overlay data can also include timing information, indicating the time at which the overlay data was entered and/or captured by the capture component 202. The timing data can be used to synchronize the overlay data with the live media stream.

In another embodiment of the present disclosure, capture component 202 replicates the received overlay data to memory caches 206, 208, 210, 212, and 214 where it is cached for distribution to client viewers. Replicating the overlay data to a number of memory caches increases the robustness and scalability of the overlay data distribution system.

Once the overlay data is replicated to the memory caches, contextualization component 216 can analyze the data overlay data and contextualize the overlay data in response to the analysis. In some embodiments, contextualization component 216 can analyze the overlay data in response to a request for overlay data from a client viewer. The contextualization performed on the overlay data can be based on information associated with the client player, or viewer of the broadcast. In other aspects of the disclosure, the contextualization can be based on information associated with the overlay data input operator, the subject of the broadcast, or an origin of the broadcast.

When contextualization component 216 contextualizes the overlay data based on the client viewer, the analysis performed by contextualization component 216 can include analysis of location information, demographic information, and/or information about a recipient of the of the contextualized overlay data. The information analyzed can include preferences of the recipient, broadcast viewing usage and history of the recipient.

It is to be appreciated that while FIG. 2 depicts contextualization component 216 contextualizing the overlay data after it has been replicated to memory caches 206, 208, 210, 212, and 214, contextualization component 216 can also contextualize the overlay data using contextualization information prior to replication to the memory caches. In that embodiment of the present disclosure, the contextualized overlay data can be replicated to memory caches, and overlay component 218 transmits the overlay data to the target recipients directly from the memory caches.

After the overlay data is contextualized, overlay component 218 can transmit the contextualized overlay data along with a live media stream to a viewer of the live media stream. The live media stream can be received from a media source 220 that can be part of a content delivery network, or an ingestion pipeline. The media source 220 can have processed the live media stream such that the live media stream is ready to be viewed in a player. Overlay component 218 can transmit the live media stream and the contextualized overlay data in separate channels or bands, so that the overlay data and the live media stream remain separate. Keeping the overlay data separate from the live media stream allows changes and processing to the overlay data without having to process the entire live media stream that can be orders of magnitude larger in bandwidth and/or size.

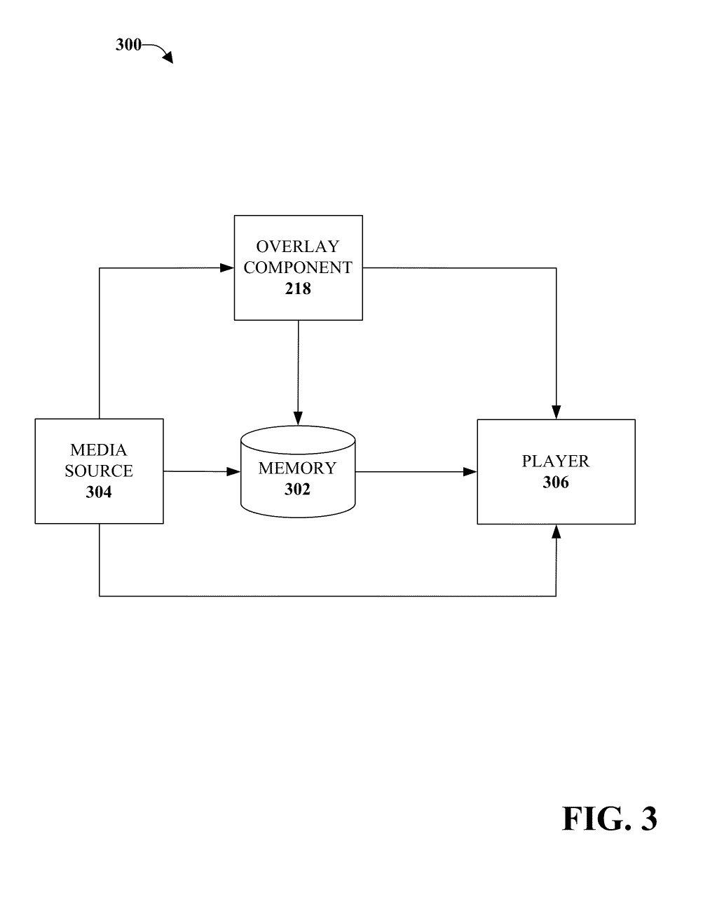

FIG. 3 illustrates an example, non-limiting embodiment of a system that can store live streaming media for video on demand playback in accordance with the present disclosure. System 300 can include an overlay component 218, a media source 304, a memory 302 and a player 306.

Overlay component 218 can transmit the live media stream and the contextualized overlay data in separate channels to a player 306 as described above with regard to FIG. 2. The live media stream can come from a media source 304 which can be part of a content distribution network, memory cache, or ingestion pipeline. Player 306 can also receive the live media stream directly from media source 304, and receive the contextualized overlay data separately via overlay component 218.

In an embodiment of the present disclosure, media source 304 and overlay component 218 can also transmit the live media stream and the contextualized overlay data to a memory 302 for storage. Player 306 can access the live media stream and contextualized overlay data at a later time during the live broadcast, or after the broadcast has been completed. Storing the live media stream and the contextualized overlay data in memory 302 can allow for video-on-demand streaming or download of the media.

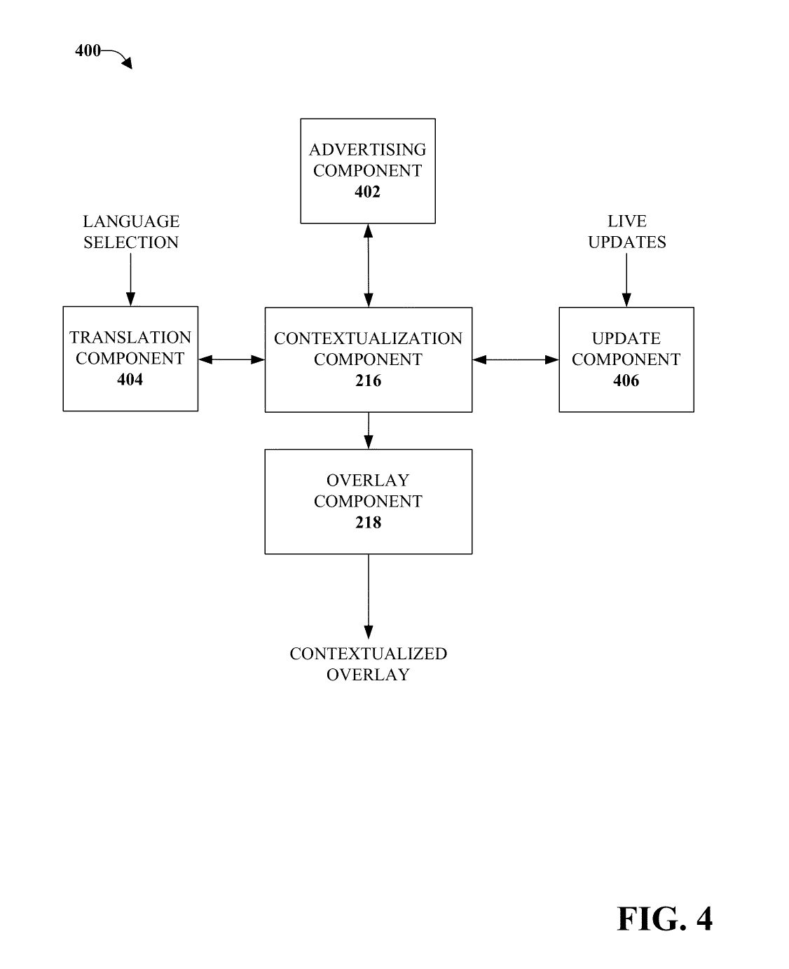

Turning now to FIG. 4, a block diagram illustrating an example, non-limiting embodiment of a system that contextualizes overlays is shown. In addition to the contextualization component 216 that contextualizes the overlay data and the overlay component 218 that transmits the contextualized overlay data with the live media stream, system 400 can include an advertising component 402, a translation component 404, and an update component 406.

Advertising component 402 inserts advertisements into the contextualized overlay data based on the contextualization. Advertising component 402 can analyze the contextualized overlay data and provide relevant and targeted advertisements based on the overlay data. The contextualized overlay data can provide information about the location, demographics, and historical trends of the origin and/or targeted recipient of the overlay data. The advertising component 402 can provide advertisements based on the content of the overlay data as well as these contextualizations. The content of the overlays that the advertising component 402 can analyze include text in the overlays as well as images. Image recognition algorithms employed by the advertising component 402 can be used to analyze images in the overlay data.

Translation component 404 translates the overlay data into a selected language in response to receiving a request for translation to the selected language. The request for translation can originate with a user who is watching the live media stream along with the overlays. The request for translation can also be based on a system language of the computing device that is viewing the live media stream. The request can also be based on past language selections and preferences. Translation component 404 can also automatically translate the overlay data based on location information associated with the source and/or recipient of the overlay data and live media stream. The translation component 404 can perform the translation using custom machine translation algorithms and can also outsource the translation to cloud services that provide translation services.

Update component 406 can receive live updates to overlay information and update the contextualized overlay data in response to the live updates. Live updates can be based on updates entered by an operator observing an event. Live updates can also be based on dynamic information gathered from publicly available sources. Examples of live updates can include race results and updated betting odds on the outcome of a sporting event as the event progresses. These updates can be received by the update component 406 which can receive the contextualized overlay data from the contextualization component 216 and update the contextualized overlay data with the live updates.

The updated contextualized overlay data from the update component 406 can be stored in memory 302 for future reference and video on demand viewing at a later time. The updated contextualized overlay data can also be replicated to memory caches 206, 208, 210, 212, and 214 for delivery by the overlay component 218 to the targeted recipients.

The update component 406 can receive the live updates as they are manually entered by an operator. Update component 406 can also receive the live updates automatically. Update component 406 can perform a search for updates in some embodiments. In other embodiments, update component 406 can subscribe to feeds (such as RSS) that provide live updates such as RSS feeds.

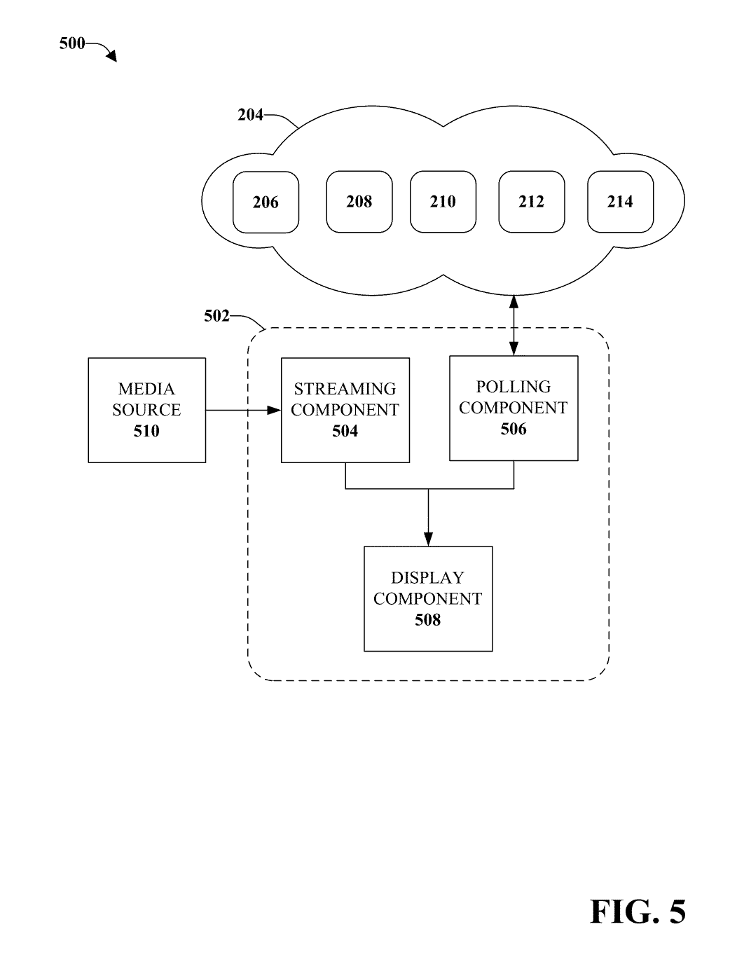

Turning now to FIG. 5, a block diagram illustrating an example, non-limiting embodiment of a system 500 that can receive and display contextualized overlays is shown. System 500 can include a player 502 that can play a live media stream with contextual overlays that are downloaded separately from the live media stream. Player 502 includes a streaming component 504 that downloads and/or streams a live media stream from media source 510. A polling component 506 polls memory caches 206, 208, 210, 212, and 214 for an overlay associated with the live media stream and downloads the overlay separately from the live media stream in response to detecting an overlay. Player 502 also includes a display component 508 that synchronizes the overlay with the live media stream and displays the live media stream with the overlay and a timeline mark in a media stream timeline.

The media source 510 that streaming component 504 downloads and/or streams the live media stream from can be at least one of a content delivery network, an ingestion pipeline, or a media storage unit (e.g. memory 302). Media streamed from the media storage unit can be media that was saved for video-on-demand streaming after the live event has finished.

In addition to polling memory caches 206, 208, 210, 212, and 214 for overlay data associated with the live media stream, polling component 506 can also poll memory 302 for overlay data. Polling component 506 can check for updated overlay data at memory 302 and memory caches 206, 208, 210, 212, and 214 at regular intervals. The regular intervals can be once per a time period (e.g., once per second, minute, etc.). The interval can also be based on the number of frames (e.g., once per ten frames) or some other characteristic of the media stream. Overlays can include expiration times in the metadata associated with the overlays, and polling component 506 can automatically check for new overlays upon expiration of the overlay. In some embodiments, polling component 506 can download all of the overlay data each time that it polls the memory caches and in other embodiments, polling component 506 can download new overlay data that has been created or modified since the last time polling component 506 polled the memory cache.

The display component 508 can synchronize the overlay downloaded by polling component 506 with the media stream and display the media stream with the overlay. The overlay data can include information about what time periods of the media stream the overlay data corresponds to. Display component 508 can use that information to display the overlay data at the corresponding time during playback of the media stream.

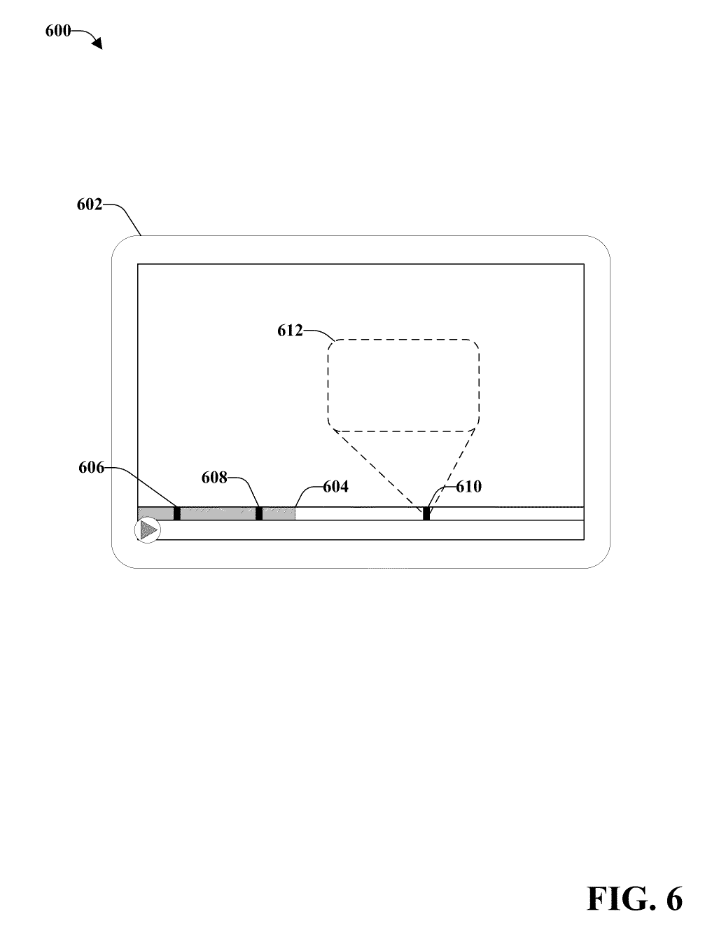

Turning now to FIG. 6, a block diagram illustrating an example, non-limiting embodiment of a system 600 that can display timeline marks is shown. In system 600, the display 602 outputted by display component 508 is shown. Display component 508 can display timeline marks 606, 608, and 610 in a media stream timeline 604. The timeline mark can indicate a presence and a time of an overlay.

As the display component 508 displays the media stream with the overlays overlaying the media stream, the display component 508 can show the progress of the media stream with the timeline 604. Display component 508 can embed timeline marks 606, 608, and 610 into the timeline alerting a viewer that an overlay exists as well as showing when it will appear in the media display. Timeline marks 606 and 608 show that an overlay was previously displayed alongside the media, and timeline mark 610 shows that an overlay will appear. The display component 508 can display a popup 612 showing a preview of the overlay when a cursor is placed over the timeline mark.

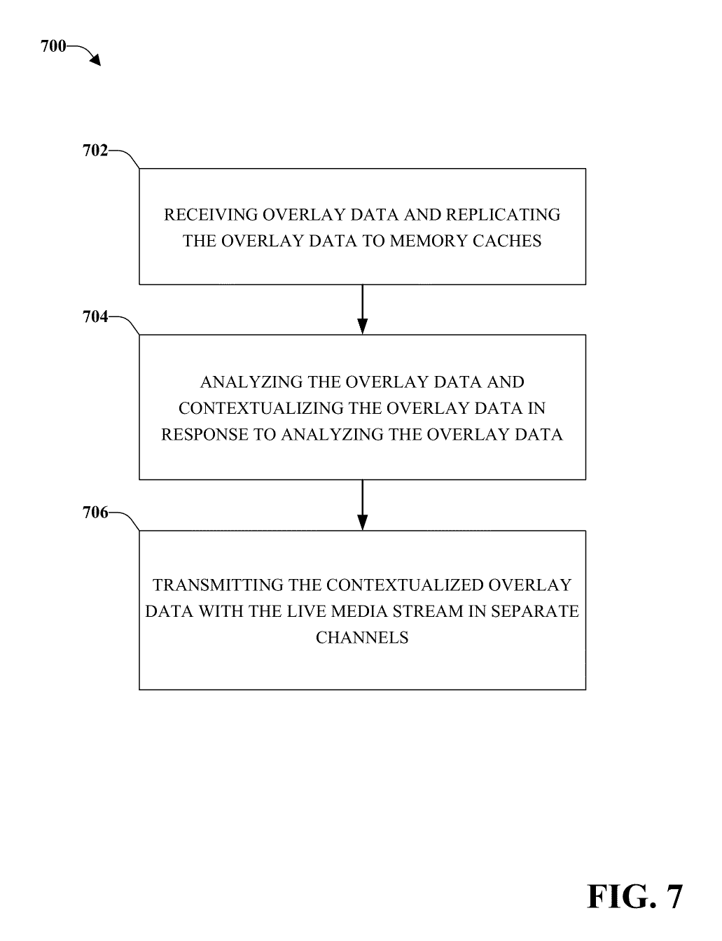

FIG. 7 shows a flow diagram of a method 700 for contextualizing overlay data in accordance with various aspects and implementations described herein.

At 702, the method includes receiving overlay data and replicating the overlay data to a memory cache. The overlay data can be received from an overlay data operator that enters the overlay data based on a live broadcast. The overlay data can provide context and additional information related to the events occurring on the live broadcast. The overlay data entered by the operator can also inform viewers of the live broadcast about upcoming and past events and it can be textual content or image based. The overlay data can also include timing information that indicates the time at which the overlay data was entered and/or captured. The timing data can be used to synchronize the overlay data with the live media stream.

At 704, the method includes analyzing the overlay data and contextualizing the overlay data in response to analyzing the overlay data. The analysis can take into account location information, demographic information, an origin of the overlay data, and a recipient of the overlay data. The contextualizing can make the overlay data relevant and useful for the viewer and can be based on information associated with the client player or viewer of the broadcast. In other aspects of the disclosure, the contextualization can be based on information associated with the overlay data input operator, the subject of the broadcast, or an origin of the broadcast.

At 706, the method includes transmitting the contextualized overlay data with the live media stream in separate channels. Keeping the overlay data separate from the live media stream allows changes and processing to the overlay data without having to process the entire live media stream which can possibly be orders of magnitude larger in bandwidth and/or size.

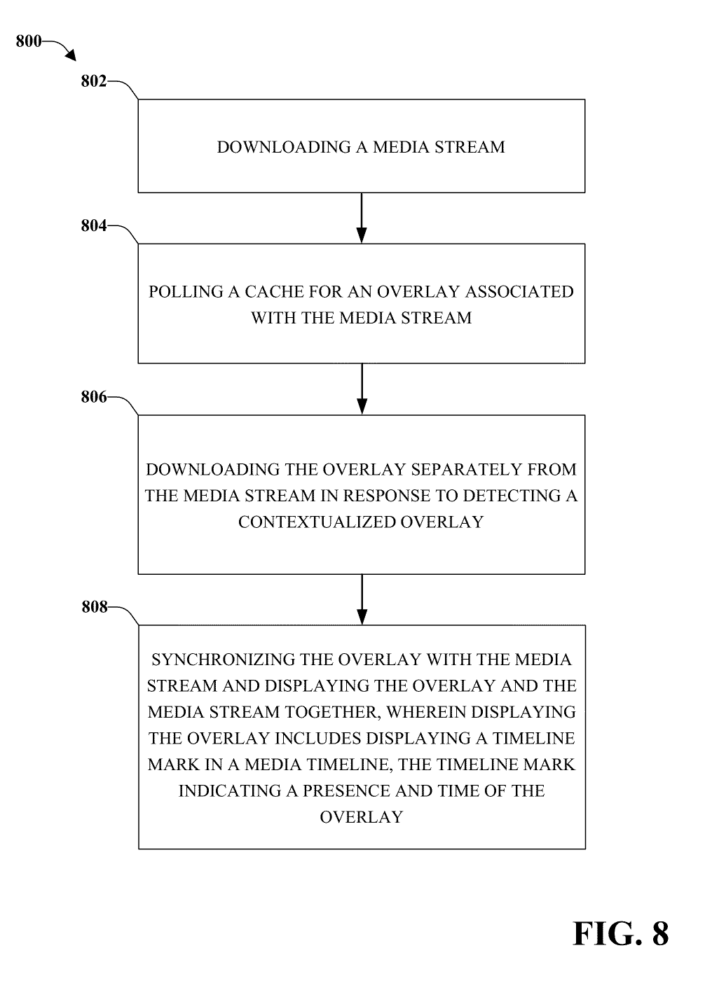

FIG. 8 shows a flow diagram of a method 800 for receiving and synchronizing overlay data in accordance with various aspects and implementations described herein. At 802, a media stream is downloaded from a memory cache, a content delivery network or an ingestion pipeline. The media stream can be a live media stream that is streaming, or it can be a media stream that has been stored and is being viewed on demand.

At 804, a memory cache is polled for an overlay that is associated with the media stream. The memory cache can be polled at regular intervals for updates to overlays associated with the media stream. At 806, in response to detecting an overlay, the overlay can be downloaded separately from the media stream, in order to minimize bandwidth costs. Updates to the overlay data can be downloaded separately as well, in order to avoid downloading the entire set of overlay data again.

At 808, the method includes synchronizing the overlay with the media stream and displaying the overlay and the media stream together. The method can include displaying a timeline mark in a media timeline where the timeline mark indicates a presence and time of the overlay.

### Exemplary Computing Device

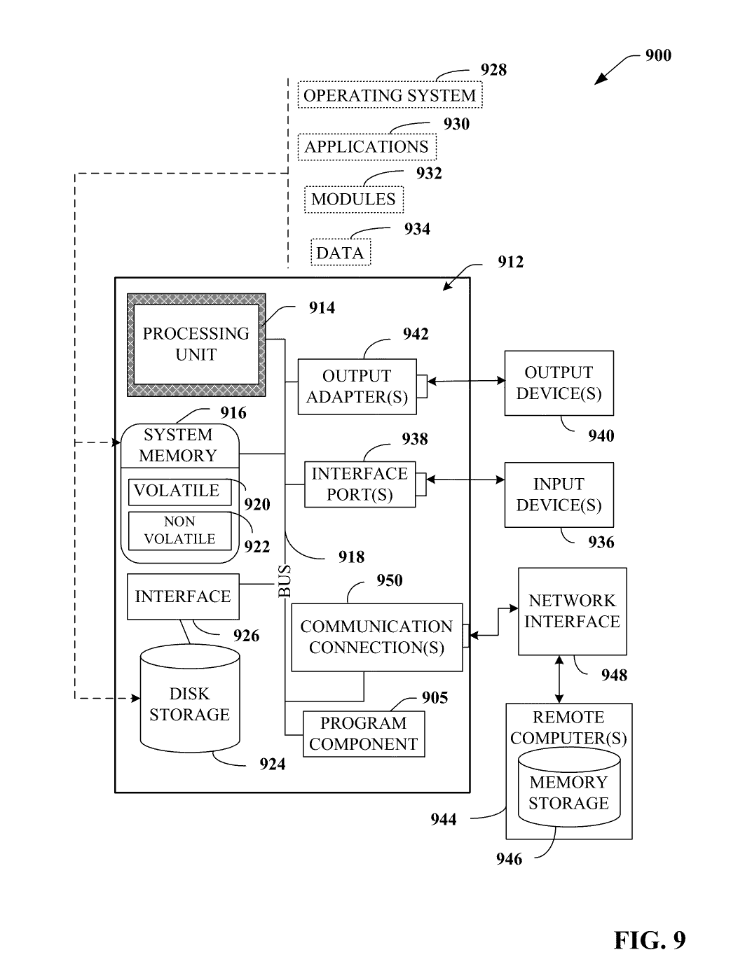

With reference to FIG. 9, a suitable environment 900 for implementing various aspects of this disclosure includes a computing device 912. It is to be appreciated that the computer 912 can be used in connection with implementing one or more of the systems or component shown and described in connection with FIGS. 1-6. The computing device 912 includes a processing unit(s) 914, a system memory 916, and a system bus 918. The system bus 918 couples system components including, but not limited to, the system memory 916 to the processing unit 914. The processing unit(s) 914 can be any of various available processors. Dual microprocessors and other multiprocessor architectures also can be employed as the processing unit(s) 914.

The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 994), and Small Computer Systems Interface (SCSI).

The system memory 916 includes volatile memory 920 and nonvolatile memory 922. The basic input/output system (BIOS), containing the basic routines to transfer information between elements within the computing device 912, such as during start-up, is stored in nonvolatile memory 922. By way of illustration, and not limitation, nonvolatile memory (e.g., 922) can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory (e.g., 920) includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM. Additionally, the disclosed memory components of systems or methods herein are intended to include, without being limited to including, these and any other suitable types of memory.

Computing device 912 can also include removable/non-removable, volatile/non-volatile computer storage media. FIG. 9 illustrates, for example, a disk storage 924. Disk storage 924 includes, but is not limited to, devices like a magnetic disk drive, flash drive, floppy disk drive, tape drive, Jaz drive, Zip drive, LS-100 drive, flash memory card, or memory stick. The disk storage 924 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used, such as interface 926.

FIG. 9 also depicts software that acts as an intermediary between users and the basic computer resources described in the suitable operating environment 900. Such software includes, for example, an operating system 928. Operating system 928, which can be stored on disk storage 924, acts to control and allocate resources of the computing device 912. System applications 930 take advantage of the management of resources by operating system 928 through program modules 932 and program data 934, e.g., stored either in system memory 916 or on disk storage 924. It is to be appreciated that this disclosure can be implemented with various operating systems or combinations of operating systems.

A user enters commands or information into the computing device 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computing device 912, and to output information from computing device 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computing device 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computing device 912. For purposes of brevity, only a memory storage device 946 is illustrated with remote computer(s) 944. Remote computer(s) 944 is logically connected to computing device 912 through a network interface 948 and then physically connected via communication connection 950. Network interface 948 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computing device 912, it can also be external to computing device 912. The hardware/software necessary for connection to the network interface 948 includes, for exemplary purposes only, internal and external technologies such as, modems including regular telephone grade modems, cable modems and DSL modems, ISDN adapters, Ethernet cards, and wireless networking cards.

In accordance with various aspects and implementations, the computing device 912 can be used to add, attach, and transmit data for overlays in near real time as events occur during a live broadcast. As more fully disclosed herein, in some implementations, the computing device 912 can include one or more processors (e.g., 914) that can be used to process data, including processing data to perform various tasks (e.g., receiving overlay data, analyzing and contextualizing the overlay data, transmitting the overlay data, downloading a media stream, polling a cache, downloading the overlay, and synchronizing and displaying the overlay and the media stream, etc.). The computing device 912 can include a program component 905 that can be associated with (e.g., communicatively connected to) the one or more processors. The program component 905 can contain, for example, a capture component, a contextualization, an overlay component, a streaming component, a polling component, a display component, and/or other components, which can respectively function as more fully disclosed herein, to facilitate embodiments of the disclosure described herein.

### Exemplary Networked and Distributed Environments

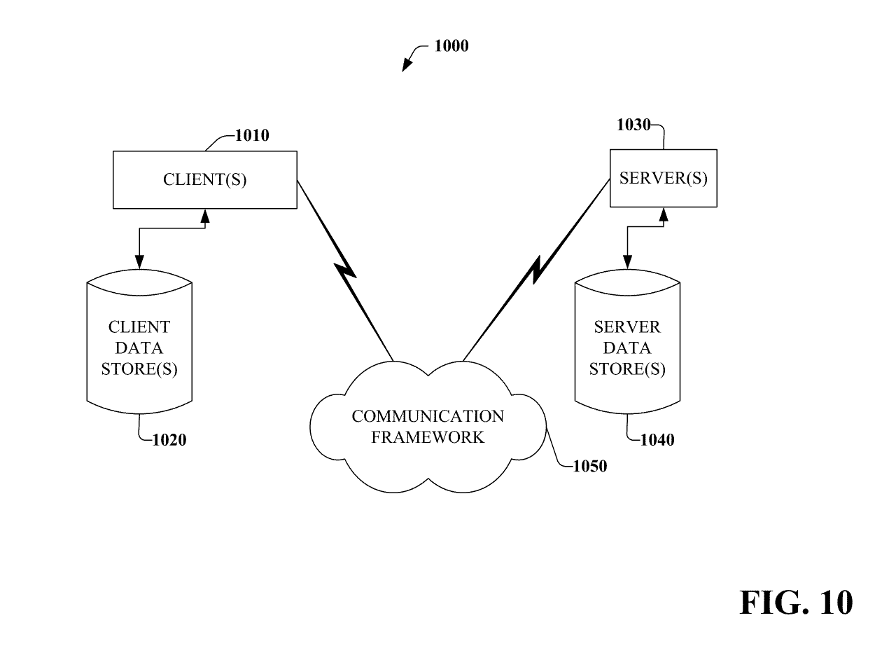

FIG. 10 is a schematic block diagram of a sample-computing environment 1000 in accordance with implementations of this disclosure. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing this disclosure, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. The client(s) 1010 are operatively connected to one or more client data store(s) 1020 that can be employed to store information local to the client(s) 1010. Similarly, the server(s) 1030 are operatively connected to one or more server data store(s) 1040 that can be employed to store information local to the servers 1030.

It is to be appreciated and understood that components, as described with regard to a particular system or method, can include the same or similar functionality as respective components (e.g., respectively named components or similarly named components) as described with regard to other systems or methods disclosed herein.

It is to be noted that aspects or features of this disclosure can be used with substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be used with legacy telecommunication technologies, e.g., GSM. In addition, mobile as well non-mobile networks (e.g., the Internet, data service network such as internet protocol television (IPTV), etc.) can be used with aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system. In the cloud computing system, computing can be delivered as a service, rather than a product. Thus, resources, software, and information can be shared between computers and servers over a network. End-users access cloud-based applications through a web browser, or other light weight dektop or mobile app while the business software and data are stored on servers at remote locations.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Reference throughout this specification to “one implementation,” or “an implementation,” or “one embodiment,” or “an embodiment” means that a particular feature, structure, or characteristic described in connection with the implementation or embodiment is included in at least one implementation or one embodiment. Thus, the appearances of the phrase “in one implementation,” or “in an implementation,” or “in one embodiment,” or “in an embodiment” in various places throughout this specification can, but are not necessarily, referring to the same implementation or embodiment, depending on the circumstances. Furthermore, the particular features, structures, or characteristics may be combined in any suitable manner in one or more implementations or embodiments.

Various aspects or features described herein can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

What has been described above includes examples of systems and methods of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a memory that has stored thereon computer executable components;
a processor that executes the following computer executable components stored in the memory:
a capture component that receives overlay data and replicates the overlay data to memory caches;
a contextualization component that analyzes the overlay data and contextualizes the overlay data in response to analyzing the overlay data; and
an overlay component that transmits the contextualized overlay data with a live media stream, wherein contextualized overlay data is transmitted in a separate channel from the live media stream.

2. The system of claim 1, further comprising a storage component that stores the contextualized overlay data and the live media stream for playback as video on demand.

3. The system of claim 2, wherein the storage component stores the contextualized overlay data and the live media stream as they are transmitted.

4. The system of claim 1, further comprising a translation component that translates the overlay data into a selected language in response to receiving a request for translation to the selected language.

5. The system of claim 1, further comprising an update component that receives live updates to overlay information and updates the contextualized overlay data in response to the live updates.

6. The system of claim 1, wherein the contextualization component contextualizes the overlay data based on at least one of location information, demographic information, an origin of the overlay data, and a recipient of the contextualized overlay data.

7. The system of claim 1, further comprising an advertising component that inserts advertisements into the contextualized overlay data based on the contextualization.

8. A method, comprising:
using a processor to execute computer executable instructions stored in a memory to perform the following acts:
receiving overlay data and replicating the overlay data to a memory cache;
analyzing the overlay data and contextualizing the overlay data in response to analyzing the overlay data; and
transmitting contextualized overlay data with a live media stream in separate channels.

9. The method of claim 8, further comprising storing the contextualized overlay data and the live media stream as the live media stream and contextualized overlay data are transmitted.

10. The method of claim 8, further comprising translating the overlay data into a selected language in response to receiving a request for translation to the selected language.

11. The method of claim 8, further comprising updating the contextualized overlay data with live updates as the live updates to the overlay data are received.

12. The method of claim 8, wherein the contextualizing the overlay data comprises contextualizing the overlay data based on at least one of location information, demographic information, an origin of the overlay data, and a recipient of the contextualized overlay data.

13. The method of claim 8, further comprising inserting advertisements into the contextualized overlay data based on the contextualizing the overlay data.

14. A system, comprising:
a memory that has stored thereon computer executable components;
a processor that executes the following computer executable components stored in the memory:
a streaming component that downloads a media stream;
a polling component that polls a cache for an overlay associated with the media stream and downloads the overlay separately from the media stream in response to detecting an overlay; and
a display component that synchronizes the overlay with the media stream and displays the media stream with the overlay and a timeline mark in a media stream timeline.

15. The system of claim 14, wherein the media stream is a live media stream.

16. The system of claim 14, wherein the polling component polls the cache at regular intervals, and requests overlays created since a previous poll.

17. The system of claim 14, wherein the timeline mark indicates a presence and time of an overlay.

18. The system of claim 14, wherein the display component displays a popup showing the overlay when a cursor is placed over the timeline mark.

19. A method, comprising:
using a processor to execute computer executable instructions stored in a memory to perform the following acts:
downloading a media stream;
polling a cache for an overlay associated with the media stream;
downloading the overlay separately from the media stream in response to detecting a contextualized overlay; and
synchronizing the overlay with the media stream and displaying the overlay and the media stream together, wherein displaying the overlay includes displaying a timeline mark in a media timeline, the timeline mark indicating a presence and time of the overlay.

20. The method of claim 19, wherein the downloading the media stream comprises downloading a live media stream.

21. The method of claim 19, further comprising polling the cache at regular intervals and requesting overlays created since a previous poll.

22. The method of claim 19, further comprising displaying a popup showing the overlay in response to a cursor being placed over the timeline mark.
